(19) United States
(12) Patent Application Publication
(10) Pub. No.: US 2024/0228064 A9
(43) Pub. Date: Jul. 11, 2024

(54) A reusable floating device for launching a space rocket from high altitude, and method for launching a rigid structure into space

(71) Applicant: Szabolcs TAKÁCS, Fuzesabony (HU)

(72) Inventor: Szabolcs TAKÁCS, Fuzesabony (HU)

(21) Appl. No.: 18/376,646

(22) Filed: Oct. 4, 2023

Related U.S. Application Data
(63) Continuation-in-part of application No. 17/437,916, filed on Sep. 10, 2021, now abandoned.

(30) Foreign Application Priority Data
Mar. 21, 2019 (HU) P1900085

(51) Int. Cl. B64G 5/00

(52) U.S. Cl. CPC B64G 5/00; B64G 2005/005

(57) ABSTRACT

A reusable floating device suitable for launching a space rocket has a support structure which includes a toroidal balloon housing and a rigid platform attached thereto; an elongated rigid structure surrounded by said support structure, releasably connected thereto, and adapted for attachment to a space rocket;
at least one buoyant gas balloon within said balloon housing; and
a compressor module and at least one rigid-walled tank carried by said platform. The compressor module is in confined flow communication with the at least one buoyant gas balloon and the at least one rigid-walled tank.

### CROSS-REFERENCE TO RELATED APPLICATIONS

This application is a continuation-in-part of U.S. application Ser. No. 17/437,916, filed Sep. 10, 2021, a national phase of PCT/HU2020/050007, filed Mar. 10, 2020, which claims priority to Hungarian Application No. P1900085, filed Mar. 21, 2019, each of which is incorporated herein in its entirety.

### FIELD OF INVENTION

The present invention relates to a reusable floating device for launching a space rocket from high altitude and its use.

### BACKGROUND OF INVENTION

Currently, space rocket is the only known device that can deliver payloads or humans to space. A space rocket (or simply a rocket) is a reactive device in which thrust is provided by a high velocity gas produced by the combustion of solid or liquid propellant.

Space rockets are most often launched from sea level, ground-based space centers (e.g. Cape Canaveral, Kennedy, Baikonur, etc.), or from sea launch stations (e.g. Sea Lunch). The atmosphere exerts a braking force (air drag) to the launched rocket which is proportional to the square of the velocity of the rocket. Since the rocket is already traveling at very high speeds in the lower parts of the atmosphere, the braking effect of the atmosphere is significant, thus, a huge portion of the fuel is used to compensate for the air resistance of the atmosphere. Therefore, a rocket launched from sea level needs a lot of fuel, so the rocket itself must be large, which significantly increases the cost of launching.

As is known, as the altitude increases the density of the air decreases. About 80% of the mass of the atmosphere is below 18 km above sea level. Most of the air resistance on the rocket, therefore, occurs during transit across the troposphere and the bottom of the stratosphere. That is, the negative effect of air resistance can be significantly reduced by launching a rocket from high altitude.

Rockets launched from aircrafts have been used for decades to launch small satellites into low Earth orbit (LEO). An example of such a rocket is the Pegasus, developed by Orbital Sciences Corporation, which is a three-stage solid booster. The launching takes place in two phases. As a first step, the Pegasus (for example, with the help of a Lockheed L-1011 aircraft) is brought to an altitude of 12 km. During the second phase, the rocket is released and the rocket engine is ignited after reaching the desired height. The advantage of this solution is that smaller rockets are needed to bring a given payload to space, thus costs can also be reduced. The disadvantage of this solution is that the size of the rocket is significantly limited by the carrying capacity of the carrier aircraft, which means that only a few hundred kg (up to 443 kg in the case of Pegasus) can be launched into space.

Another way to launch rockets from the atmosphere is to lift the rocket to an altitude of several kilometers using an inflatable balloon, then release it from the balloon and start the engines. One of these, the so-called rockoon has been disclosed in the U.S. Patent Application No. 2018/0290767. The concept of this solution is to attach a suitably sized inflatable balloon to a specially designed (flat) multi-stage rocket to lift the rocket to an altitude of 20-30 km. Once the desired height is reached, the rocket is released, the engines are ignited, and the rocket is set to orbit normally. The advantage of this solution is that the launch of the rocket from high altitude can save a significant amount of fuel (the traditional first stage is practically omitted), thus a smaller rocket is needed to launch a specific payload. Another advantage is that, due to the weaker atmosphere, rocket shapes and engines that are different from traditional rockets can be designed. Rocket nozzles designed for lower atmospheric pressures are larger, and therefore more efficient and less expensive. Because weather effects are mainly limited to the troposphere (atmosphere below about 10 km), rocket launches above the troposphere are virtually unaffected by weather conditions, thus the cost of postponing conventional launches can be saved.

The disadvantage of current rockoon solutions is that they are capable of delivering only a lightweight rocket, thus a small payload, to outer space. Another disadvantage is that the buoyant gas in the balloon (e.g. hydrogen, helium) is simply released after the launch or left to lose with the balloon. These two drawbacks are related, since current rockoon systems are specifically designed for small rockets. Accordingly, the size of the required balloon does not justify reusing the gas contained in the balloon or the balloon itself. In case of the current solutions, there is no launch platform. A further disadvantage is that in the present solutions, the position and movement of the rockoon are substantially determined by the wind, which makes it difficult to launch.

Some of the above problems are overcome by the solution described in US 2005/0116091, which discloses a multi-component platform for launching a space rocket from high altitude. The main components of the system are at least one helium-filled oblong airships, a tank-holding module connected to the airships containing a rigid tank and a compressor, and a winged rocket platform. The gist of this solution is to lift the rocket to high altitude using the platform and then accelerate the entire system to a horizontal speed of several hundred or thousands of kilometers per hour before launching the rocket.

U.S. Pat. No. 6,119,983 discloses a space rocket with a rigid structure attached to the top of it. After takeoff, the unit rises as an airship due to the hydrogen stored in the rigid structure and then rises as a rocket using the stored hydrogen as fuel.

While the above solutions are capable of launching rockets from a height, they do not allow the launch of the rigid structures (and a significant amount of gas contained in them) into space.

The inventor has realized that there is currently no reusable floating device capable of launching rockets for carrying tons of payloads into space. It has also been discovered that in current rockoon systems, the balloon or gas in the balloon is not recycled after launching, which increases costs and, due to the disposable design, limits the size of the rocket to be launched.

The inventor has realized that, after launching a rocket, the gas contained in the balloons can be pumped into rigid-walled tanks, thus being reusable later, and the balloon can be returned to the ground as planned. Because units other than the rocket can now be reused, floating devices that contain larger-than-ever balloons can be provided and economically operated and with which larger-scale rockets can be launched from high altitude.

It has also been realized that there is currently no method for delivering a rigid structure and the gas contained therein into space, which rigid structure is comparable to a carrier rocket, or larger. The inventor has have realized that many applications of a rigid structure and the buoyant gas stored therein, especially hydrogen, are possible in outer space (see below). The inventor has also realized that the floating device of the present invention enables the launch of such a rigid structure and the gas stored therein into space.

### SUMMARY OF INVENTION

The present invention provides an apparatus and method that is free from the disadvantages of the prior art. A reusable floating device that can deliver payloads (or humans) to space at a lower cost than at present, and to deliver a rigid structure to space is provided.

The reusable floating device includes a toroidal balloon housing and a rigid platform attached to the balloon housing. An elongated rigid structure is releasably connected to the support structure which surrounds the elongated rigid structure. The elongated rigid structure is adapted for attachment to a space rocket. At least one buoyant gas balloon is provided within the toroidal balloon housing. A compressor module and at least one rigid-walled tank are carried by the rigid platform. The compressor module is in a confined flow communication with the at least one buoyant gas balloon and the at least one rigid-walled tank. Preferred embodiments of the invention are defined in the dependent claims.

### BRIEF DESCRIPTION OF THE DRAWINGS

In the drawings,

FIG. 1 is a schematic perspective view of an exemplary embodiment of a floating device according to the invention in space-rocket-coupled state,

FIG. 2 is a schematic top view of the floating device shown in FIG. 1,

FIG. 3 is a schematic view showing the floating device shown in FIG. 1 after the space rocket has been released,

FIG. 4 is a schematic sectional view showing the main structural elements of the first and rigid platforms.

FIG. 5 is a schematic view showing the main structural elements of an exemplary rigid structure.

### DESCRIPTION OF PREFERRED EMBODIMENTS

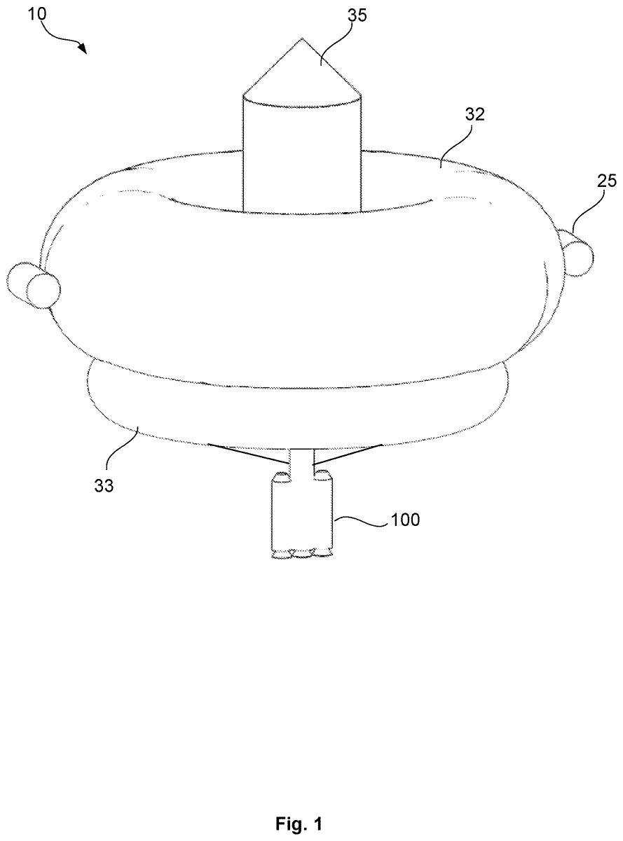

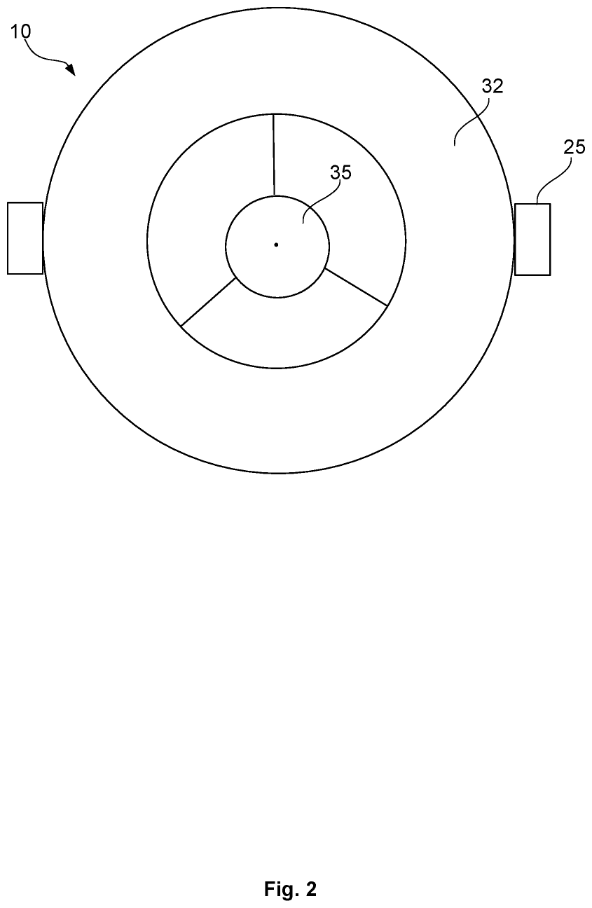

FIGS. 1 and 2 are schematic, non-scaled perspective and top views of an exemplary embodiment of the floating device 10 of the present invention. The device 10 is adapted to launch a space rocket 100 from a high altitude (several kilometers above sea level). In the context of the present invention, space rocket 100 refers to a device which works on reactive principle as previously described, with a solid or liquid propellant, such as a known type of rocket (Falcon, Atlas, Delta, etc.) or a rocket specially designed to be launched from the atmosphere in the future.

The device 10 of the present invention comprises a support structure 20 which includes a toroidal balloon housing 32 and a rigid platform 33 attached thereto. At least one buoyant gas (e.g. hydrogen or helium) filled balloon 30 is arranged inside the toroidal-shaped balloon housing 32. The device 10 further comprises at least one rigid-walled tank 12 and a compressor module 40 in confined flow communication with the at least one buoyant gas balloon 30. In other words, the compressor module 40 is connected to the at least one balloon 30 and the rigid-walled tanks 12 for transporting hydrogen or helium from the at least one balloon 30 to the at least one rigid-walled tank 12 or vice-versa. The at least one rigid-walled tank 12 and the compressor module 40 are carried by the rigid platform 33. In a preferred embodiment shown in FIG. 1, the balloon housing 32 and the rigid platform 33 are arranged in contact with one another, attached to each other. The balloon housing 32 and the rigid platform 33 preferably comprise frame structures defining the shape of the balloon housing 32 and the rigid platform 33, preferably made of carbon fiber, and further comprise outer covers (shells), made of poly-paraphenylene terephthalamide, and the like, covering the frame structures.

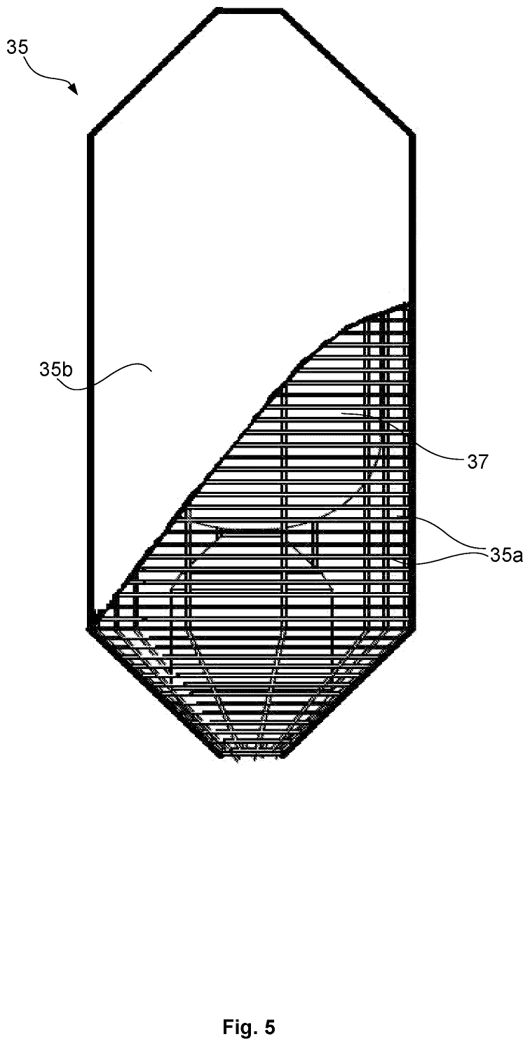

The device 10 of the present invention comprises a hydrogen or helium filled, preferably cigar-shaped, rigid structure 35 adapted for attachment to the top portion of the rocket 100, and releasably attached to the support structure 20. The rigid structure 35 comprises a frame 35a, preferably made of carbon fiber, defining the shape of the rigid structure 35, at least one inner balloons 37 filled with hydrogen or helium, and an outer shell 35b, preferably made of poly-paraphenylene terephthalamide (for example Kevlar™), covering the rigid frame 35a, as shown in FIG. 5. The outer shell 35b may, of course, be made of other materials of suitable density and strength, such as composite, as will be apparent to those skilled in the art. At least one inner balloons 37 may also be made of latex or a similar material. It is noted that in the context of the present invention, a rigid structure means that the volume delimited by the frame structure 35a and the outer shell 35b is substantially constant.

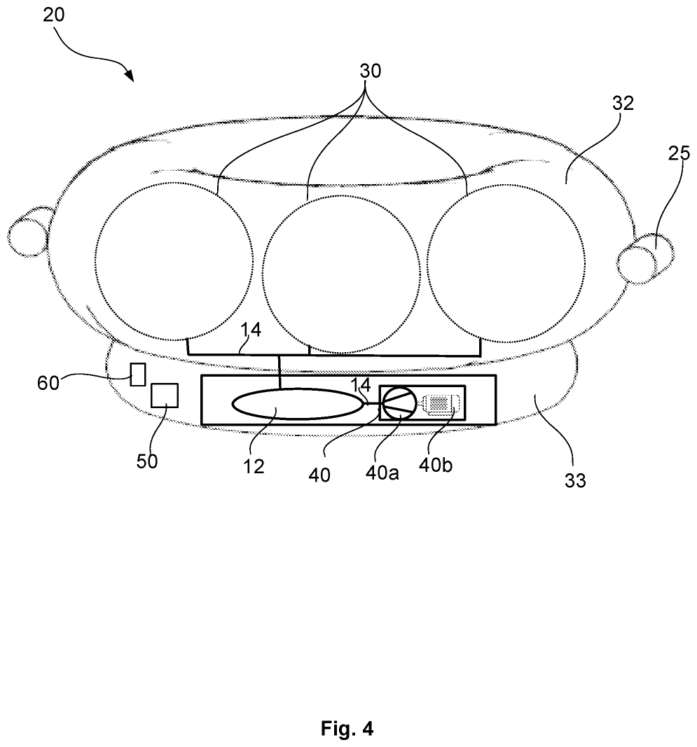

As can be seen in FIG. 4, the at least one balloon 30 is arranged inside the toroidal-shaped rigid balloon housing 32. The rigid-walled tanks 12 and the compressor module 40 are carried by the rigid platform 33, and the balloon housing 32 and the rigid platform 33 comprise frame structures (not shown in the figures) made of carbon fiber and exterior shells made of Kevlar™ covering the frame structures. The balloon housing 32 and the rigid platform 33 form the support structure 20 and the space rocket 100 is releasably connected to the support structure 20 through the rigid structure 35. The balloon housing 32 and the rigid platform 33 are dimensioned so as to surround the rigid structure 35 circumferentially, such that the rigid structure 35 can pass through the interior of the torus (see FIG. 1).

The balloon housing 32 is designed to transmit the lifting force of the at least one balloon 30 to the space rocket 100 releasably attached to the balloon housing 32 and rigid platform 33. The balloons 30 are made of a resilient material, such as reinforced-wall latex and the like, which withstands extreme temperature and pressure conditions in the upper layers of the atmosphere and which, when expanded, have a uniform thickness. For example, the at least one balloon 30 may be spherical or droplet shaped (as the ones used as meteorological balloons), which balloons 30 are dimensioned in such as to lift the floating device 10 and its attached space rocket 100. In a particularly preferred embodiment, the at least one balloon 30 is dimensioned to raise the floating device 10 and the attached space rocket 100 to an altitude in the range of 10,000 to 30,000 meters.

The device 10 of the present invention further comprises at least one rigid-walled tank 12 and a compressor module 40 in confined flow communication with the at least one buoyant gas balloon 30 and the at least one rigid-walled tank 12 for transporting buoyant gas from the at least one balloon 30 to the at least one rigid-walled tank 12 or vice-versa, as shown, for example, in FIG. 4. Preferably, the at least one rigid-walled tank 12 is made of metal (e.g., aluminum or steel) and are connected to the at least one balloon 30 through the compressor module 40 via a pressure-tight pipeline 14. In a preferred embodiment, the rigid platform 33 is hollow and the at least one rigid-walled tank 12 and the compressor module 40 are arranged within the rigid platform 33. The compressor module 40 includes at least one compressor 40a for introducing a buoyant gas such as hydrogen or helium into the balloon 30 through the pipeline 14, and for boosting gas pressure and reducing gas volume, and drive unit 40b for operating the compressor 40a. The compressor 40a may be any known type of compressor (e.g., piston compressor) suitable for pumping a buoyant gas such as hydrogen or helium in the at least one balloon 30 into the rigid-walled tank 12. The drive unit 40b may be, for example, a battery-driven electric motor or an internal combustion engine as known to those skilled in the art.

In a particularly preferred embodiment, at least one propulsion engine 25 for maneuvering the floating device 10 is attached to the balloon housing 32 as shown, for example, in FIG. 1. It is noted that in the context of the present invention, maneuvering means the ability to rotate the device 10 horizontally and/or vertically. The propulsion engine 25 may be, for example, a propeller engine, a propeller gas turbine, or a jet engine for moving the device 10 in the desired direction. The device 10 may advantageously be provided with a navigation module 50 (e.g., a GPS module) for determining the geographical position of the device 10, and with a central IT unit 60 for controlling the at least one propulsions engine 25 connected to the navigation module 50. Preferably, the central IT unit 60 is a computer capable of controlling the at least one propulsion engine 25 based on, for example, a navigation module 50 signal or a wireless signal (e.g., a radio signal) from a ground control center.

In the following, some possible embodiments of the device 10 according to the invention are illustrated by some hypothetical calculation examples.

### Example 1

In this embodiment, the space rocket 100 is a Falcon 9 v1.0 booster with a mass of 335 tons. The device 10 contains ten balloons 30 each of 150 meters in diameter, made of latex of 1 cm thickness. The balloons 30 are filled with hydrogen and weigh 161 tons each (including hydrogen). Ten aluminum rigid-walled tanks 12, each having a volume of 4.500 cubic meters, are arranged in the rigid platform 33. The total weight of the balloon housing 32 and the rigid platform 33, the tanks 12 and the compressor module 40 is 150 tons. The total mass of the 10 platforms and the space rocket 100 is thus approximately 2.100 tons and the displaced volume is 17,700,000 cubic meters. That is, the average density of the system is 0.118 kg/cubic meter. The device 10, together with the rocket 100, rises until the average density of the system equals the density of the air at that altitude. The 0.118 kg/cubic meter air density is the density which can be measured at 18.5 km above sea level, so the device 10 and the rocket 100 according to this example will rise 18.5 km.

### Example 2

In this embodiment, the device 10 includes a cigar-shaped rigid structure 35. The inner balloon 37 is filled with hydrogen. It is 500 meters long and 50 meters in diameter and has a volume of approx. 1,150,000 cubic meters. The carbon fiber frame structure 35a is 700 meters long and 60 meters in diameter. The outer shell 35b is made of Kevlar™ and having a wall thickness of 2 centimeters. The weight of the rigid structure 35 is thus approx. 130 tons. In this case, the space rocket 100 is a Satum V launch vehicle weighing 2.860 tons, and the device 10 contains ten spherical balloons 30, each 150 meters in diameter, made of latex with a wall thickness of 1 centimeter. The total weight of the 30 balloons is 1610 tons. The combined weight of the balloon housing 32 and the rigid platform 33, the tanks 12 and the compressor module 40 in this embodiment is approx. 400 tons. The total weight of the device 10 and the space rocket 100 is thus approximately 5,000 tons, and the displaced volume is 19,000,000 cubic meters. Thus, the average density of the system is 0.26 kg/cubic meter. The density value of 0.26 kg/cubic meter is equal to the air density measured at an altitude of 13 km above sea level, i.e. the device 10 of the above example, together with the rigid structures 35 and space rocket 100, can rise up to the bottom of the stratosphere at an altitude of 13 km.

It is noted that in the above examples, the weights of the space rockets 100 which were used in the past or which are still being used were the weights that are calculated for launching from sea level. However, it is known, that a significant portion of the mass of the space rocket 100 is made up by the propellant. Therefore, in the case of launching from the stratosphere, due to the rarer atmosphere there and the higher potential energy, significantly less propellant is required to reach the same orbit. That is, a space rocket 100 having the same mass and launched from an altitude can orbit more payload as its counterpart launched from sea level, or less propellant is required to orbit the same mass of payload. This ultimately reduces the cost per useful unit mass.

The invention further relates to a method for launching rigid structures 35 into space. In the following, the operation of the device 10 will be described in connection with the method of the present invention.

As mentioned, the rigid structures 35 have many applications in the space. In the case of hydrogen filling gas, for example, the hydrogen in the inner balloon 37 can be used as a propellant for spacecrafts or can be converted to water at space stations, while energy can be obtained from the chemical reaction. Due to its radiation-absorbing properties, hydrogen is excellent for use in radiation shields, which are much needed in space. The frame structure 35a and the shell 35b of the rigid structure 35 can be used, for example, to form structural elements of space stations or space hotels or, if appropriate, to build bases for other celestial bodies (e.g. on the Moon or Mars).

In the method according to the invention, the rigid structure 35 is attached to the top portion of the space rocket 100 and is lifted together with the space rocket 100 by means of the floating device 10 described above, in the following manner. After connecting the rigid structure 35 to the support structure 20, the inner balloon 37 and the at least one balloons 30 are filled with hydrogen or helium. As a result, the volume (i.e., air displacement) of the system increases and its density decreases. It is noted that while the rigid balloon 35 increases the buoyancy of the device 10, it alone would not be able to lift the space rocket 100 to a suitable height. The device 10 may optionally be secured to the ground, for example by means of cables, while the inner balloon 37 and balloon 30 are being inflated, as will be apparent to those skilled in the art. Note that, if necessary, an embodiment is conceivable in which at least one a portion of the hydrogen or helium required to fill the inner balloon 37 and balloon 30 is contained in the at least one rigid-walled tanks 12 and the inner balloon 37 and balloons 30 are filled as the device 10 rises. In a particularly preferred embodiment, the rigid structure 35 and the space rocket 100 attached thereto are lifted to an altitude in the range of 10,000 to 30,000 meters above sea level by means of the floating device 10. At this altitude, the above-mentioned benefits of launching from high altitude are apparent. In a preferred embodiment, the position of the device 10 can be stabilized and the device 10 can be moved to the desired launching position by the at least one propulsion engines 25.

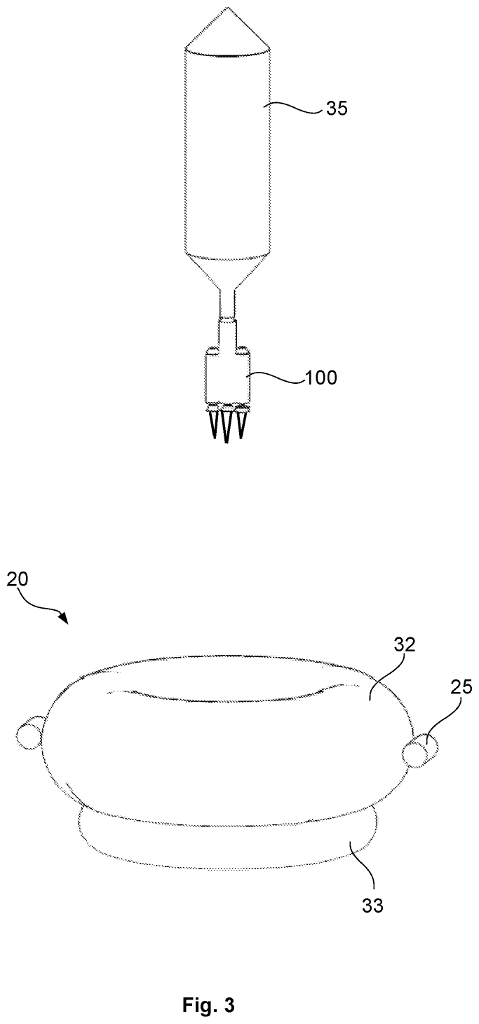

After reaching the maximum altitude using the floating device 10, i.e. the height at which the buoyancy of the system formed by the device 10 and the space rocket 100 is equal to the gravitational force acting on the system, the rigid structure 35 is disconnected from the floating device 10 together with the space rocket 100 connected thereto. That is, the releasable connection between the rigid structure 35 and the support structure 20 is activated. The resulting disconnection can be achieved in several ways, for example, by a signal from a pressure sensor that detects the height of the device 10. Before or after the disconnection, the engine of the space rocket 100 is started and the rigid structure 35 is launched into orbit by the space rocket 100. In a possible embodiment, after disconnection, the space rocket 100 begins to sink with the rigid structure 35 attached thereto and move away from the device 10. In contrast, in the embodiment shown in FIG. 3, it is not necessary for the space rocket 100 and the rigid balloon 35 to move downward relative to the device 10 prior to launching the space rocket 100; the space rocket 100 may also pass through the device 10. Namely, the balloon housing 32 and the rigid platform 33 made of Kevlar™ protect the balloons 30 from the heat of the engine of the space rocket 100. The engine of the space rocket 100 can thus be started before the disconnection. The advantage of launching the space rocket 100 through the device 10 is that in this way no valuable altitude is lost as the space rocket 100 sinks, thereby saving fuel or increasing the radius of the orbit of the space rocket 100.

Once the space rocket 100 has been disconnected from the device 10, a portion of the hydrogen or helium in the balloons 30 begins to be delivered to at least one tank 12 by means of the compressor module 40. As a result, the volume of the at least one balloon 30 is reduced, i.e., the buoyancy of the device 10 is reduced as well. By reducing the amount of hydrogen or helium in the at least one balloon 30, it is possible for the device 10 to sink to the desired altitude or even sea level and to be recovered. By means of the at least one propulsion engine 25, the device 10 can be returned to the launch site, for example to a ground center.

Various modifications to the above disclosed embodiments will be apparent to a person skilled in the art without departing from the scope of protection determined by the attached claims.

1. A reusable floating device suitable for launching a space rocket and comprising a support structure which includes a toroidal balloon housing and a rigid platform attached thereto;
an elongated rigid structure surrounded by said support structure, releasably connected thereto, and adapted for attachment to a space rocket;
at least one buoyant gas balloon within said balloon housing; and
a compressor module and at least one rigid-walled tank carried by said platform, the compressor module in confined flow communication with the at least one buoyant gas balloon and the at least one rigid-walled tank.

2. The floating device according to claim 1, characterized in that the rigid platform is located under the toroidal balloon housing.

3. The floating device according to claim 1, characterized in that the rigid structure has a cigar-shape and is attachable to a top portion of the space rocket.

4. The floating device according to claim 1, characterized in that the balloon housing and the rigid platform comprise frame structures defining shape of the balloon housing and the rigid platform.

5. The floating device according to claim 4, characterized in that the frame structures made of carbon fiber, and comprise outer shells, preferably made of poly-paraphenylene terephthalamide, covering the frame structures.

6. The floating device according to claim 1, characterized in that the balloon housing and the rigid platform are connected.

7. Floating device according claim 1, characterized in that the rigid structure comprises a frame defining shape of the rigid structure and an outer shell covering the frame structure.

8. Floating device according claim 7, characterized in that the frame of the rigid structure is made of carbon fiber, and the outer shell is made of poly-paraphenylene terephthalamide.

9. The floating device according to claim 1, characterized in that the at least one balloon is dimensioned to lift the floating device and the space rocket connected thereto to an altitude of at least 10,000 meters above sea level.

10. The floating device according to claim 1, characterized in that the at least one balloon is made of a flexible material.

11. The floating device according to claim 1, characterized in that at least one propulsion engine for maneuvering the floating device is connected to the toroidal balloon housing.

12. The floating device according to claim 1, characterized in that it comprises a navigation module for determining the geographical position of the floating device and a central IT unit connected to the navigation module for controlling the at least one propulsion engine.

13. A method of launching the rigid structure according to claim 1 into space, comprising:
attaching the rigid structure to a top portion of a space rocket, and lifting the rigid structure together with the space rocket with the floating device,
separating the rigid structure and the space rocket attached thereto from the floating device at the maximum height achievable by means of the floating device, and
starting an engine of the space rocket and positioning the rigid structure into orbit around the Earth.

14. Method according to claim 13, characterized in that the rigid structure and the space rocket connected thereto are lifted to an altitude in the range of 10,000 to 30,000 meters above sea level by means of the floating device.
